(19) United States
(12) Patent Application Publication
(10) Pub. No.: US 2008/0033700 A1
(43) Pub. Date: Feb. 7, 2008

(54) Apparatus and method for analyzing design change impact on product development process

(75) Inventors: Makoto Kano, Yokohama (JP); Akio Koide, Yokohama (JP); Mika Saito, Yamato (JP); Takeo Yoshizawa, Kawasaki (JP)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/881,479

(22) Filed: Jul. 27, 2007

(30) Foreign Application Priority Data
Aug. 4, 2006 (JP) 2006-213821

(51) Int. Cl. G06F 17/50

(52) U.S. Cl. 703/1

(57) ABSTRACT

An impact of a change in design information is defined as a sum of an additional work amount that must be reworked in each design process referring to the design information. At a time of requesting an impact analysis of a design change, all processes referring to certain design information to be changed are extracted from a project monitoring unit. An impact of the change in the referred design information on each extracted process is calculated. With respect to design information created on the basis of the referred design information in each extracted process, the maturity levels at a time when the process makes a reference and at a time when the reference design information is changed are obtained. Then, the difference therebetween is determined as the work amount that may possibly become useless.

### FIELD OF THE INVENTION

The present invention relates to an apparatus and method for analyzing a change impact in product development processes. More specifically, the present invention relates to an apparatus and a method for analyzing an impact which a design change at runtime of a product development process makes on another development process.

### BACKGROUND OF THE INVENTION

Heretofore, various methods have been proposed related to methods and tools for managing various types of projects such as a product development project, a method for analyzing a software change, and a method for optimizing a project structure.

For example, Japanese Patent Application Laid-open Publication No. 2004-240486 discloses the following method as a project management method and a tool for implementing the method. With this method, when a change in design information of a deliverable is requested, engineers involved are informed of the change request. In addition, this method allows an influence of the deliverable change to be analyzed by identifying deliverables and tasks that may possibly be influenced by the proposed change request. This analysis is made on the basis of information on past similar processes, and information on predefined dependencies between processes relating to each of the deliverables thus identified.

In addition, many software change analysis methods used in software developments have been proposed in particular (see reference to Barbara G. Ryder and Frank Tip, “Change impact analysis for object-oriented programs,” in Proceedings of PASTE 2001, PP. 46-53, June 2001, and Jun Han, “Supporting impact analysis and change propagation in software engineering environments,” in Proceedings of the 8th Intl. Workshop on Software Technology and Engineering Practice (STEP′ 97), PP. 172-182, July 1997. Proposed in Barbara G. Ryder and Frank Tip, “Change impact analysis for object-oriented programs,” in Proceedings of PASTE 2001, PP. 46-53, June 2001 is a method for determining a range of change impact on source codes in an object-oriented language, and this method especially aims to select regression tests for an implemented change. This method pays attention to method dispatch behavior at runtime that may be affected by several types (adding a class, creating a method, or the like) of source code edits (i.e., changes). By using a technique for checking the method dispatch behavior, and a technique using a call-graph, this proposed method makes it possible to select regression tests needed because of a certain edition in the source codes.

On the other hand, unlike the foregoing method, Jun Han, “Supporting impact analysis and change propagation in software engineering environments,” in Proceedings of the 8th Intl. Workshop on Software Technology and Engineering Practice (STEP′ 97), PP. 172-182 proposes methods not based on a particular type of software artifact. In the methods, all the software artifacts (including their components) and dependencies among them are defined by type. In addition to the above defining, consistency properties that the dependencies among the software artifacts and their component must satisfy are specified. After such a preparation, when a software artifact and its dependencies are changed (such changes are also defined by type), modifications needed to maintain the consistency are identified by using the dependencies and the consistency properties. Then, in order to select the modifications that are actually needed among the identified modifications, this method causes an inquiry to be made to a user. In addition, in this method, change pattern rules are defined in advance, in each of which a certain change requires which and what kind of modification, and then the modifications matching the rules are determined as modifications to be actually performed.

Alternatively, as the project structure optimization method, Tyson R. Browning and Steven D. Eppinger, “Modeling impacts of Process architecture on cost and schedule risk in product development,” IEEE TRANSACTIONS ON ENGINEERING MANAGEMENT, Vol. 49, No. 4, November 2002 proposes a simulation technique for optimizing architecture of a process (a configuration of processes, as a whole, such as what order of executing the processes and what timing of starting the processes to be employed). In this method, a change impact is modeled on assumption that a change in a deliverable leads to a rework of processes using (receiving an input from) the changed deliverable.

In general, a change in a plan and design occurring in the works for a project makes a high impact on other tasks, thereby increasing work periods and costs. For this reason, an appropriate management for such a change is an important activity in a project management. In order to implement such a change management, it is necessary to know the range and the degree of an impact that a certain change in one process makes on another process (to perform a change impact analysis).

However, obtaining such information is generally difficult work requiring time and cost. For example, in a case of many actual development projects, when a change request is received, a change impact is estimated for each task by interviewing a person in charge, and then a final change impact on the entire project is estimated by summing up the estimations. Thereafter, on the basis of the estimated change impact, a set of countermeasures for handling the change request is made and carried out. In the course of making the countermeasures, each of the countermeasures may require a change in a different piece of design information. For this reason, it is necessary to estimate the impact caused by each of the countermeasures. In addition, when the cost for handling the change request is higher than the value obtained by its change, a consideration needs to be made as to whether or not to accept the change request.

As such, in fact, a large amount of time and cost are needed between the time of receiving a change request and the time of determining a set of countermeasures for handling the change request. Under such circumstances, for example, even if an engineer gets an idea that may contribute to a certain quality improvement, the engineer cannot estimate the resultant impact easily. Thereby the engineer may become hesitant, which could lead to deterioration of product quality as a whole. In addition, when it takes a long time to determine countermeasures for a change request after the reception of the request, the suspension of other related tasks for avoiding rework may increase an idling time. Otherwise, the engineer may advance the tasks without being aware of the change request. These are highly likely to increase the degree of a change impact to become greater than the magnitude at the time when the estimation is started.

The foregoing conventional techniques include several methods for improving efficiency in the change impact analysis. However, a large number of processes are concurrently implemented in collaborative development employed in an automobile development or the like, and deliverables are designed in detail while exchanging ad hoc incomplete design information among the processes in the course of the implementation. For this reason, the kinds of dependencies that may occur among the processes often cannot be identified in advance. In this case, a change impact cannot be estimated appropriately by using the conventional change impact analysis methods. To be specific, only static information is used in the conventional methods, the information such as dependencies among pieces of information, dependencies among processes, and times required for past similar processes. Accordingly, there is a need for a low-cost change impact analysis method applicable to a project including parallel development.

However, it is not possible to apply the method described in Japanese Patent Application Laid-open Publication No. 2004-240486 to a project such as an automobile development project in which the collaborative development is implemented among a large number of task levels, since when and what kinds of dependencies will occur among deliverables cannot be identified in advance.

Moreover, an output of necessary regression tests is obtained as a result of the change impact analysis, and the content of the analysis is limited within the range of the change impact. Accordingly, the time and cost required for modifying the change impact are not quantified, and an impact on schedule and costs in the project cannot be directly determined. In addition, this analysis method is based on program codes in object-oriented languages. For this reason, by using the method described in Barbara G. Ryder and Frank Tip, “Change impact analysis for object-oriented programs,” in Proceedings of PASTE 2001, PP. 46-53, June 2001, it is not possible to make a change impact analysis of general design information, which is targeted by the present invention.

Furthermore, in the case of the method described in Jun Han, “Supporting impact analysis and change propagation in software engineering environments,” in Proceedings of the 8th Intl. Workshop on Software Technology and Engineering Practice (STEP′ 97), PP. 172-182, it is possible to identify a modification that must be made for dealing with an inputted change as described earlier. However, for this purpose, it is necessary to previously define all artifacts and dependencies among them, define possible changes and the like by type, and also to define consistency properties among them. In addition, in this method, defining modification patterns corresponding to all types of changes is required for automating the change impact analysis. For this reason, this method is applicable to a case, such as software development, where forms and types of deliverables are defined in advance, but not to a case, such as an automobile development, where a large number of deliverables each having an arbitrary form are involved, and where the dependencies among them are unknown in advance. Moreover, the result of the analysis in this method is only an enumerated list of activities necessary for dealing with a change, but this method does not deal with the quantification of the necessary activities.

Additionally, the method of Tyson R. Browning and Steven D. Eppinger, “Modeling impacts of Process architecture on cost and schedule risk in product development,” IEEE TRANSACTIONS ON ENGINEERING MANAGEMENT, Vol. 49, No. 4, November 2002 is based on the assumption that each process is started by receiving a completed input. Then, in this method, modeling is performed for a case where an input stochastically changes at a time of completion of the process. In this method, degrees of change impacts only in typical cases are obtained by previously interviewing with engineers. For this reason, this method is not applicable to a case, especially like an automobile development, where dependencies are dynamically built, and cannot be known in advance.

### SUMMARY OF THE INVENTION

Against this background, in consideration of the foregoing problems, an object of the present invention is to provide a low-cost impact analysis method. Specifically, a method is desired which does not need a large number of user input or preparatory information on defined dependencies among processes, for a change impact analysis. This method may be applied in the course of an arbitrary development project handling deliverables and design information, and including parallel development.

The following apparatus is provided as one aspect of the present invention. The apparatus is used for analyzing the impact which a change in one piece of design information makes on another piece of design information in a design and development process, and includes an input unit, a change impact computing unit and an output unit. The input unit receives input of a piece (called a change target piece, below) of design information to be changed, and the change scale of the change target piece of design information. The change impact computing unit computes the change impact on a creation process of creating a piece of design information referring to the change target piece of design information, on the basis of the change target piece of design information, the change scale, the dependency between the pieces of design information, the dependency level, and the work amount after making a reference in the creation process. Then, the output unit outputs the change impact to an external unit.

A feature of this apparatus is that the change impact on the process of creating a piece of design information referring to a change target piece of design information is computed and outputted on the basis of the change target piece of design information, its change scale, the dependency between the pieces of design information, the dependency level, and the work amount after making a reference in the creation process (the process of creating the design information which refers to the change target piece, after the actual reference is made).

Moreover, the change impact computing unit of this apparatus recursively computes the change impact on a certain piece of design information that indirectly refers to the change target piece of design information. This computation makes it possible to figure out, in a linked manner, an impact which a change in one piece of design information is directly or indirectly made on another piece of design information.

Note that the change scale is defined as a rework ratio that is a ratio of the work amount becoming useless due to a rework, to the work amount carried out, in the process of creating a piece of design information referring to the change target piece. In addition, the dependency level is defined as a rate at which one piece of design information depends on another piece of design information.

Furthermore, this apparatus allows a variance of an impact of a change in design information to be expressed as a probability density function (a first probability density function). Thereby, the change impact (the change impact including variance) is expressed as the first probability density function. When a completion time of another process of creating design information referring to the changed design information is expressed as another probability density function (a second probability density function), this apparatus allows the first probability density function to be analytically incorporated into the second probability density function. In other words, this apparatus updates the second probability density function of the process completion time by using the first probability density function indicting the change impact.

Moreover, this apparatus can be regarded as an invention of a method for implementing steps for the respective functions, and of a computer program that causes an arbitrary information processing apparatus, whose typical example is a computer, to function as the apparatus of the present invention.

These functions will be described in more detail hereinafter. An impact of a change in certain design information in a development process is defined as the sum of an additional work amount that must be reworked in each design process referring to the certain design information. At a time of receiving a request for an impact analysis of a design change, all of the following first, second and third processes are extracted from a system monitoring the development process (for example, a later-described project monitoring unit). Specifically, the first process is a process referring to design information to be changed, the second process is a process referring to design information created in the first process, and the third process is every one of processes linked to the second process with a reference relationship. Then, an impact of the change in the referred design information on each of the extracted processes is estimated. Firstly, two maturity levels of design information created on the basis of the referred information in each extracted process are obtained. One of the maturity levels is the one disclosed at the point when the process makes a reference, and the other is the one at the point when the referred design information is changed. Then, the difference therebetween is determined as the work amount that may possibly become useless. Here, the maturity level is an index indicating how much each of the design information has approached completion. The maturity level of the referred information at the reference time and the dependency level declared by the referring process are obtained. By using these and a change scale of the referred information, the work amount that is considered to actually become useless is figured out as a probability, out of the work amount that may possibly become useless.

### BRIEF DESCRIPTION OF THE DRAWINGS

For a more complete understanding of the present invention and the advantage thereof, reference is now made to the following description taken in conjunction with the accompanying drawings.

FIG. 1 is a diagram schematically showing a functional block of an apparatus in an embodiment of the present invention.

FIG. 2 is a diagram showing a flow of processing for a change impact computation in an embodiment of the present invention.

FIG. 3 is a diagram showing a rework computation model that is a basis of the present invention.

FIG. 4 is a diagram showing a rework computation model including a variance in a first embodiment of the present invention.

FIG. 5 is a diagram showing an example of a rework computation model in a third embodiment of the present invention.

FIG. 6 is a diagram showing a rework computation model including secondary propagation in a fourth embodiment of the present invention.

FIG. 7 is a diagram showing a task management system in a sixth embodiment of the present invention.

FIG. 8 is a diagram showing an information request screen in the task management system shown in FIG. 7.

FIG. 9 is a diagram showing an example in which the information request screen in the task management system shown in FIG. 8 is provided with entry fields for alternatives of the dependency level.

FIG. 10 is a diagram showing an example in which the information request screen in the task management system shown in FIG. 9 is provided with an entry field to enforce a constraint on the dependency level.

FIG. 11 is a diagram showing an information processing apparatus 1000 as a typical hardware configuration example of the change impact analysis apparatus in an embodiment of the present invention.

### DETAILED DESCRIPTION OF THE PREFERRED EMBODIMENT(S)

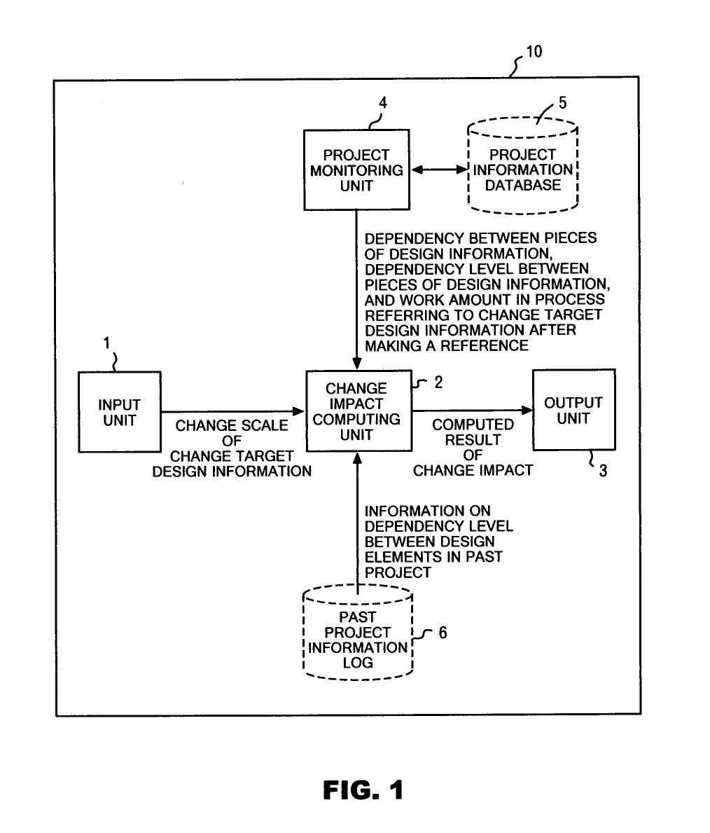

FIG. 1 is a diagram schematically showing functional blocks in a change impact analysis apparatus 10 according to the present invention. The minimum configuration of this apparatus is composed of an input unit 1, a change impact computing unit 2 and an output unit 3, and this apparatus is typically composed of a project monitoring unit 4, a project information database 5 and a past project information log 6 in addition to the above units. The change impact computing unit 2 is a central part of this apparatus. The change impact computing unit 2 receives an input of a piece of design information and its change scale, of which a user (a development engineer, in mane cases) desires to change. In addition, from the project monitoring unit 4 (actually, from information stored in the project information database 5), the change impact computing unit 2 also receives an input of the dependency between pieces of design information, the dependency level, and the work amount (the progress of a task or a time period worked for the task) after making a reference. Here, the work amount after making a reference means the work amount carried out in a process of creating a piece of design information after referring to the piece (hereinafter, called a change target piece) of design information which is to be changed. Moreover, in a case where past project information is available, the change impact computing unit 2 can obtain information such as the dependency level from the project information log 6. If the project monitoring unit 4 and the past project information log 6 are not provided, all input information can be obtained by receiving inputs from the input unit 1. The input unit 1 may be not only a user's general input device such as a keyboard or a mouse, but also another information system or a communication apparatus.

By using the below-described model and the given input information, the change impact computing unit 2 computes an impact (a change impact) which a change in one piece of design information makes on a process of creating another piece of design information. The computed change impact is outputted from the output unit 3 for a user or to another system. The output unit 3 may be a usual CRT, a usual liquid crystal display apparatus, a storage device such as a hard disk, or a communication apparatus connected to an external system.

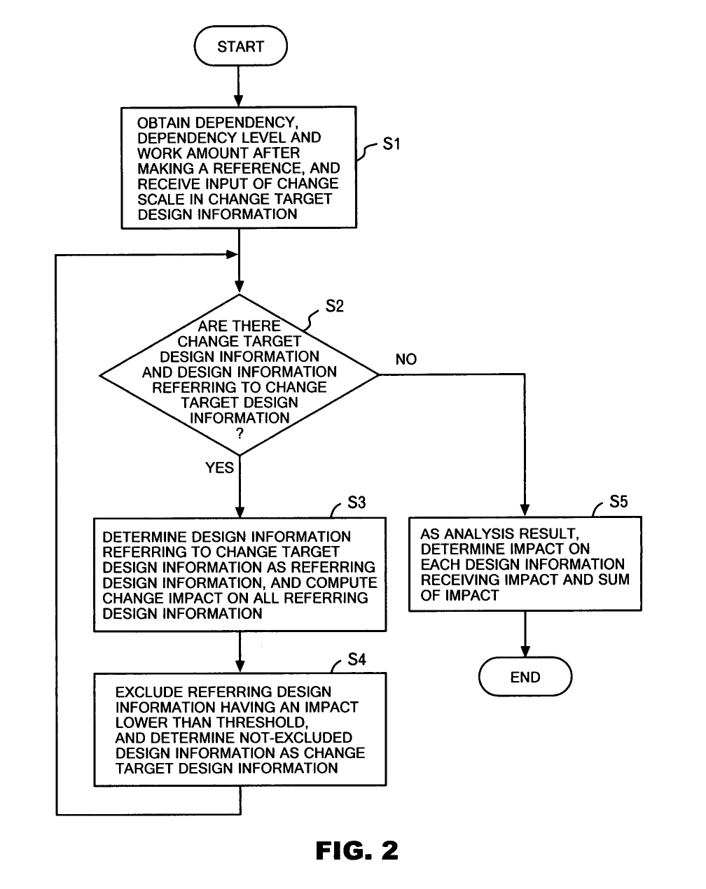

FIG. 2 shows a flow of processing executed by the change impact computing unit 2. Specifically, in step S1, the change impact computing unit 2 obtains each dependency between pieces of design information, each dependency level, and each work amount (the progress of a task or a time period worked for the task) after making a reference, which is the work amount carried out in a process of creating a piece of design information after referring to a change target piece of design information. In addition, the change impact computing unit 2 receives an input of the change scale of the change target piece of design information. Subsequently, in step S2, the change impact computing unit 2 determines whether or not there is a change target piece of design information and a piece of design information referring to the change target piece. If the determination result is Yes, the processing moves to step S3, and the change impact computing unit 2 determines each piece of design information referring to the change target piece as “a referring piece of design information,” and then computes change impacts of all of the referring pieces of design information. Moreover, in step S4, the change impact computing unit 2 excludes referring pieces of design information each having a change impact lower than a threshold, from the thus calculated referring pieces of design information, and determines the non-excluded referring pieces of design information as the change target pieces of design information. Thereafter, the processing from step S2 is repeated.

If the determination result is No in step S2, the change impact computing unit 2 determines, as an impact result, each change impact of influenced pieces of design information and the total sum of the change impacts, and terminates the processing.

In the present invention, it is assumed that a change in a first piece of information referred to by a second piece of information makes the change impact on the work time period (or the work amount) for a task creating the second piece of information, and that the change impact largely depends on “the work amount carried out by referring to the first piece of information.” On this assumption, the change impact on the referring second piece of information is defined as “the rework amount occurring because a part of (or all of) the task carried out by referring to the first piece of information becomes useless due to the change in the referred first piece of information.” As important information for estimating the rework amount determined herein, the present invention focuses on “the work amount carried out after referring to information,” that is, “the progress of a task carried out after a reference timing.” This is considered important especially in a case, such as collaborative development, where information is exchanged at an arbitrary unpredictable timing. Thus, the present invention proposes a model based on a consideration of “the progress of a task after a reference timing.”

This model makes it possible to make a change impact analysis in collaborative development or the like, though the conventional techniques have a difficulty in dealing with such a change impact analysis. Here, the model will be explained on the assumption that various inputs of information such as dependencies among pieces of design information are already obtained, the inputs being necessary requirements for this model. Then, in a later-described section, a method for obtaining them will be described. Obtaining the input information by using the method (at the timing) described in the latter section makes it possible to reduce user's manual work for input in a change impact analysis.

### Model Based on Consideration of Progress of Task After Reference Timing

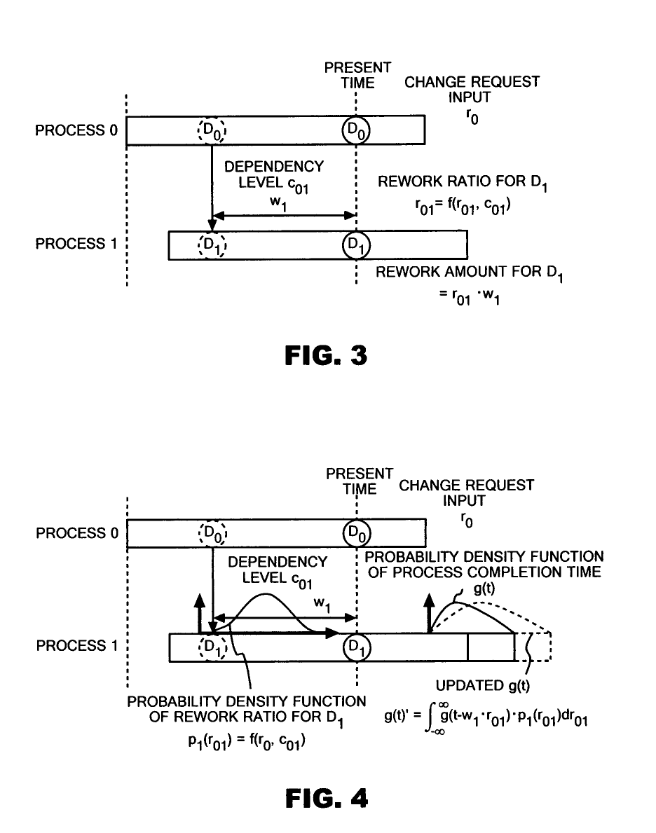

FIG. 3 shows a rework computation model that is a basis of the present invention. Here, the rework computing model will be described on the following assumption that: design information D₀ is created in a process 0; design information D₁ is created in a process 1; design information D₁ refers to design information D₀ at a certain timing; a task is progressed by the work amount w₁ from the reference time to the present time; design information D₀ is changed at the present time; r₀ is an input of a change request (a change target piece of design information and its change scale); and design information D₁ refers to design information D₀ at a certain dependency level c₀₁. Detailed descriptions will be provided later for a method of actually obtaining the values r₀, c₀₁ and w₁ and the definitions thereof.

Here, estimated is the rework amount that must be carried out for design information D₁, caused by the change in design information D₀ (this estimation is one object of the present invention). The actual rework amount is expressed as f (r₀, c₀₁)·w₁, where f denotes a function for computing a ratio (rework ratio) of the required rework amount to the total work amount w₁ after making a reference, by using inputs of the change request input r₀ and the dependency level c₀₁ (or other arbitrary information).

As described above, in this model, the rework ratio is computed by using the change request input, the dependency level in a reference relationship, and other arbitrary information, and then the rework amount occurring due to the change impact is estimated as a product of the computed rework ratio and the work amount after establishing a reference relationship. Here, appropriate adjustment of these inputs and the rework ratio computation function makes it possible to make a change impact analysis regardless of the content of design information.

### Method for Obtaining Input Information for Reducing User inputs in Change Impact Analysis

In the present invention, user input is reduced by obtaining many of the inputs needed for computing the foregoing rework amount, from information obtained during a runtime of the process. At least four kinds of inputs of “the dependency between pieces of design information,” “the work amount after making a reference,” “a change request input” and “the dependency level” are needed in order to estimate the change impact by using the model in the previous section. Among these inputs, specific methods for obtaining “the dependency between pieces of design information” and “the work amount after making a reference” will be explained in a later-described embodiment. To be more precise, “the dependency level” is concurrently obtained when various kinds of information are obtained during a runtime of a process, and thereby the change impact analysis can be achieved only by receiving “the change request input” as a user input.

### Application

If the change impact analysis is achieved at extremely low costs as described above, application of the change impact analysis to all pieces of design information makes it possible to carry out a risk analysis, for instance, for identifying which piece of design information makes a high impact on an entire project when the piece of design information is changed.

In a first embodiment, descriptions will be provided for an example in which the model defined in the section <Model Based on Consideration of Progress of Task after Reference Timing> (hereinafter, referred to as the basic model) is extended by employing a probability technique.

In the basic model, the rework ratio computation function f outputs a probability density function instead of a constant number. More specifically, the function f outputs the function indicating the probability density distribution by expressing a rework ratio as a probability variable. In this way, probability behavior of an error or the like in an estimated value and the model can be expressed. FIG. 4 shows a rework computation model including this variance. The function f (r₀, c₀₁) outputs a probability density function p₁ (r₀₁). Here, r₀₁ denotes a rework ratio, and the product of the rework ratio r₀₁ and the work amount w₁ is the rework amount. In addition, as described in a reference document, NetMBA.com, “PERT,” which can be found at that web site at the operations page (searched on 3 Jul. 2006 on the Internet), there is a known method employing variance in process completion times. More precisely, the completion time t of a process is defined as a probability variable, and the function of the probability density distribution of this variable is provided. In FIG. 4, g(t) denotes such a probability density distribution function. In this case, the probability density function p₁ (r₀₁) of the computed rework ratio can be analytically incorporated into the function g(t), and the following equation shows the probability density distribution function for the completion time of a process which is updated in response to a change impact.

$${g ( t )}^{′} = {\int }_{- ∞}^{∞} g ( t - {w}_{1} \cdot {r}_{01} ) \cdot {p}_{1} ( {r}_{01} ) d {r}_{01} \qquad [ Formula 1 ]$$

A second embodiment suggests an example in which the basic model is able to deal with an indirect (secondary) change impact as is the case with the conventional techniques. Here, “an indirect change impact” indicates a rework occurring in a process of creating a third piece of design information that is also changed due to the change impact of a second piece of design information changed due to the change impact of a first piece of design information. In this case, there is no input value of a change request input for the third piece of design information that is indirectly influenced. Accordingly, the input value is computed by using an estimated impact on the second piece of design information that the third piece of design information directly refers to.

Moreover, when a change impact computed in the foregoing way is simply added to the work amount of each process, tasks in the respective processes to deal with the change is modeled so that the tasks would be concurrently performed upon notification of the change. On the other hand, when a second piece of design information is modified after the completion of a change in a first piece of design information that the second piece of design information refers to, it is considered that a waiting time occurs in the actual process. In consideration of this waiting time, the rework amount in the second process of creating the second piece of design information can be obtained by adding, to the work time period of the second process, the rework amount (including the waiting time) occurring in the first process of creating the first piece of design information that the second piece of design information refers to. Furthermore, there is also a case, such as parallel development, where, without waiting for completion of a change in a first piece of design information that a second piece of design information refers to, a task is started, to deal with the change in a process of creating the second piece of design information. In this case, a change impact is computed in the model without consideration of a waiting time, while a change impact is computed in consideration of a waiting time in a case where the waiting time occurs.

In the foregoing descriptions of the basic model, several formulation methods for a rework ratio computation function and the like are not described specifically. Accordingly, a third embodiment shows an example of the definitions of the change request input, the dependency level, and a formulation method of the rework ratio computation function.

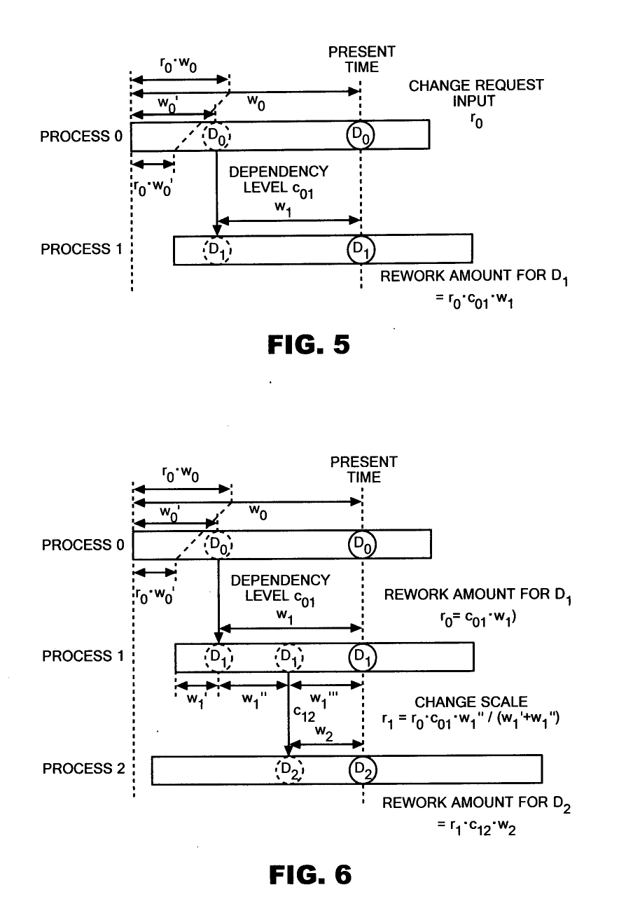

Firstly, suppose that design information D₁ is created by referring to design information D₀ as shown in FIG. 5. Here, suppose that the design information D₀ is the target for a change, the change request input r₀ denotes an index indicating how many percentage of a task already completed for creating the design information D₀ must be reworked (hereinafter, this index is referred to as a change scale), and the dependency level c₀₁ denotes an index indicating how many percentage of the task creating the design information D₁ is based on the design information D₀. When w₁ denotes the work amount carried out for the design information D₁ from the time of referring to the design information D₀ to the present time, the rework amount required for the design information D₁ caused by the change in the design information D₀ is r₀·c₀₁·w₁. In other words, here, the product of the inputted change scale and the dependency level is employed as the rework ratio computation function.

A concept of this model will be explained bellow. Firstly, the change scale r₀ of the design information D₀ is determined by a change request. Thereby, the task of the work amount r₀·w₀ must be carried out again (that is, reworked) in the process 0. At this point, an information amount referred to by the design information D₁ is only an information amount created in a work w₀′ of the total work carried out in the process 0. Here, in order to estimate the impact on the design information D₁ (a caused rework amount) due to a change in the design information D₀, it is necessary to identify how much amount of the work w₀′ is to be reworked, that is, how much amount of the design information D₀ created in the work w₀′ becomes useless.

However, it is difficult to precisely estimate this amount at a work site. For this reason, here assume that the entire work amount used for creating the design information D₀ in the process 0 becomes useless uniformly at any timing. On this assumption, it is possible to consider that the work amount r₀·w₀′ becomes useless in the work amount w₀′ in the process 0 of creating the design information D₀ to which the design information D₁ refers. Here, the dependency level c₀₁ indicates a ratio of the work amount required for creating the design information D₁ that is dependent on the design information D₀, to the total work amount required for creating the design information D₁, in the process 1. Moreover, only the information amount proportional to r₀ becomes useless in the design information D₀ to which the design information D₁ refers. Consequently, it can be considered that only the work amount r₀·c₀₁·w₁ becomes useless in the work amount w₁ carried out for creating the design information D₁ in the process 1.

A fourth embodiment shows how to formulate the basic model in a case where the formulation example described in the third embodiment (referred to as the formulation example of the basic model, below) handles secondary change propagation described in the second embodiment.

FIG. 6 is a diagram showing an example of a rework computation model including secondary propagation. As shown in FIG. 6, design information D₂ indirectly refers to design information D₀, and a change in the design information D₀ also makes an impact on the design information D₂. Here, a change scale r₁ influencing the design information D₂ is figured out by using a ratio of the rework amount for creating design information D₁ to the work amount carried out by referring to the design information D₁ in the process 2. In FIG. 6, the work amount w₁′+w₁″ denotes the work amount carried out by referring to the design information D₁ in the process 2. On the other hand, in the work amount w₁ (=w₁″+w₁′″) carried out for creating the design information D₁ in the process 1, the work amount r₀·c₀₁·w₁ is the rework amount. Assuming that the rework amount r₀·c₀₁·w₁ is evenly dispersed in the work amount w₁, r₀·c₀₁·w₁ is the rework amount of the process 1 in the work amount w₁′+w₁″ for creating the design information D₁ to which the process 2 refers. Eventually, r₁=r₀·c₀₁·w₁″/(w₁′+w₁″) indicates how many percentage of the work amount carried out by referring to the design information D₁ in the process 2 is changed. This r₁ is regarded as the change scale of the design information D₁ influencing the design information D₂. Thereby, the rework amount for the design information D₂ is r₁·c₁₂·w₂.

A fifth embodiment shows an example in which the formulation example of the basic model is extended by employing the probability technique described in the first embodiment. As described in the following embodiment, there is a case where not only the change request input but also the dependency level are obtained by receiving user inputs. In this case, a value of the dependency level may possibly include an error. For this reason, for example, instead of a constant number, a probability density function is employed for the dependency level, where its probability variable indicates the dependency level. This function is determined on the basis of a user input and characteristics of the user. As one example of this probability density function, a normal distribution may be employed, which uses an input value as a mean, and which uses, as dispersion, a value computed from a skill level of the user, a past error in a value estimated by the user, and the like. A possible example is as follows. In a resource management system, data indicating information on estimation accuracy of an engineer is stored in advance as a value of the dispersion in the foregoing normal distribution. Then, the information on the estimation accuracy of the engineer is automatically obtained from the information of the engineer who inputs the dependency level, and the distribution is determined. The rework ratio (or amount) thus calculated is provided as a probability, which therefore can be analytically incorporated into a schedule estimation stochastically defined.

A sixth embodiment shows a specific method for obtaining input information needed for achieving the present invention as described in the section entitled “Method for Obtaining Input Information for Reducing User inputs in Change Impact Analysis”.

Firstly, a person in charge of a process registers and updates in a system a request for a piece of information that he or she needs (an information request), and concurrently registers and updates in the system a piece of information that he or she creates (an information disclosure). Dependency between the pieces of design information can be formulated by matching the information request and information disclosure. Moreover, it is also possible to obtain the maturity level of each piece of the design information at an arbitrary point in time, by obtaining information on the maturity level of the information (the progress of a task) from another event, or from an input by the person in change of the process at a time of the information disclosure (here, an update of already-disclosed information is also called the information disclosure).

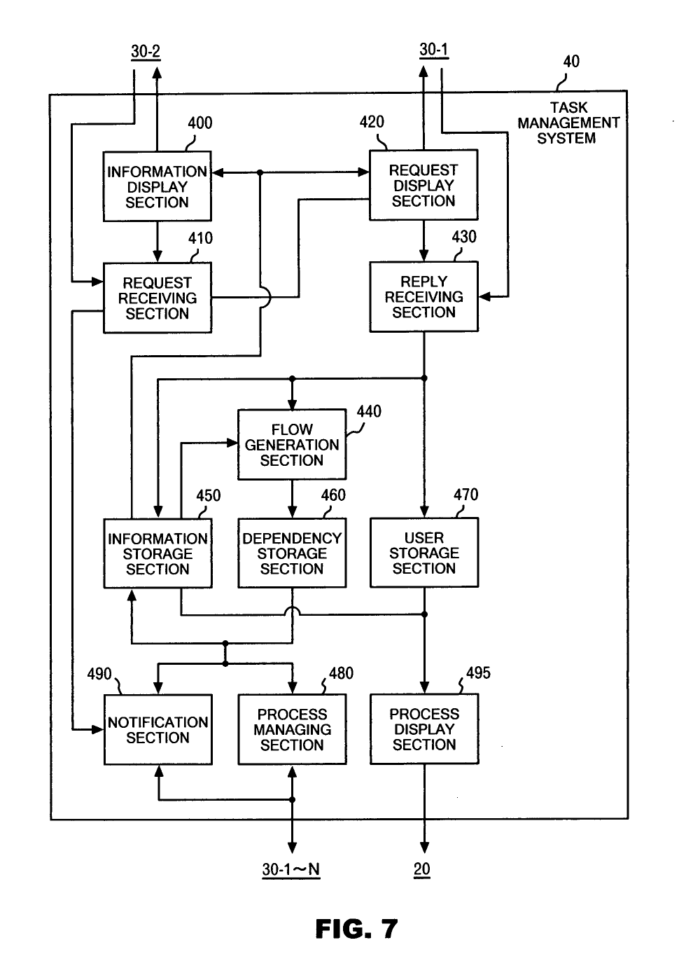

The change impact analysis of the present invention requires at least four kinds of inputs, “the dependency between pieces of design information,” “the work amount after making a reference,” “the change request input” and “the dependency level.” Among these, “the dependency between pieces of design information” and “the work amount after making a reference” can be obtained by building a task management system that will be described by referring to FIG. 7.

FIG. 7 shows an example of this task management system. In this system, an information storage section 450 stores identification information of process information in advance, and an information display section 400 displays a list of information items, in association with each piece of the identification information, on a display of a designer's terminal 30-2 of a designer concerned. The information items are included in a piece of the process information identified by using each piece of the identification information.

A request receiving section 410 receives a request from a designer of a first design process, and the request asks for process information needed for staring this first design process. A request display section 420 displays the received request to show to other designers. From any one of the other designers, a reply receiving section 430 receives a reply indicating a piece of the identification information of the requested one among pieces of the process information that the other designers respectively create in his/her design processes.

In response to a reception of the reply which is the piece of the identification information of the process information, a flow generation section 440 generates dependency information indicating that the first design process depends on the design process creating the requested process information via the requested process information.

A dependency storage section 460 generates process flow information indicating dependencies among a plurality of design processes constituting a product development project by using the processing of the flow generation section 440. A user storage section 470 stores the names and tasks of the respective designers in association with identification information of the designers. From any one of designer's terminals 30-1 to 30-N, a notification section 480 receives a notification indicating that process information in a certain design process is completed. Then, the notification section 480 detects the design process of creating process information depending on the completed and notified process information, and notifies a designer in charge of the detected design process that a requirement for starting the design process is satisfied. The designer in charge of the detected design process can be identified by referring to the user storage section 470.

A process managing section 490 further divides an already-stored design process, or creates a new design process so that the process to corresponds to a requested information item. This division or creation of the process is based on information on the requested information item, including both the maturity level and the planned offering date stored in the information storage section 450, and the maturity level and the desired offering date requested from the request receiving section 410. Then, the process managing section 490 stores the divided or newly created design processes in the information storage section 450. On a display of a manager's terminal 20, a process display section 495 displays the dependency and attribute of each of the design processes based on various kinds of information stored in the information storage section 450, the dependency storage section 460 and the user storage section 470.

“The dependency between pieces of design information” can be obtained by using such a task management system.

“The work amount after making a reference” can be obtained by using a difference between the maturity level at the time of reference, and the maturity level at the time of change impact estimation. In some cases such as a case where the maturity level is defined only as having discrete coarse levels, it also suffices to obtain the work amount by determining the progress of a task in proportion to an elapsed time after the reference timing. “The change request input” is obtained by receiving a user input when a change impact analysis is made.

As for “the dependency level,” there are several possible methods including a method of obtaining it from an input by a user who uses the information, a method of obtaining it from data or the like which have been accumulated in past times, and a method of using these two in combination.

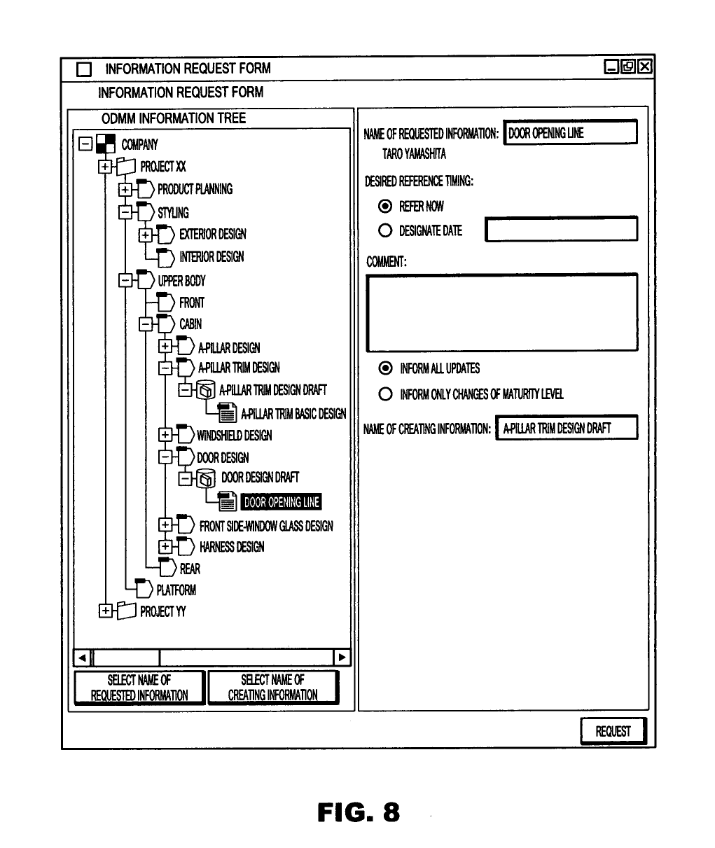

FIG. 8 is a diagram showing one example of an information request screen in the task management system shown in FIG. 7. For example, a user (a development engineer) inputs an information request to the system by using the information request screen shown in FIG. 8 through a graphical user interface (GUI). In FIG. 8, design information of “a project XX” is displayed in tree view in an on-demand maturity modeling (ODMM) information tree to the left side of the screen. The right side of the screen shows that a development engineer named “Taro Yamashita” who is going to create “a design draft of an A-pillar trim” requests information named “door opening line,” and selects “refer now” as a desired reference timing.

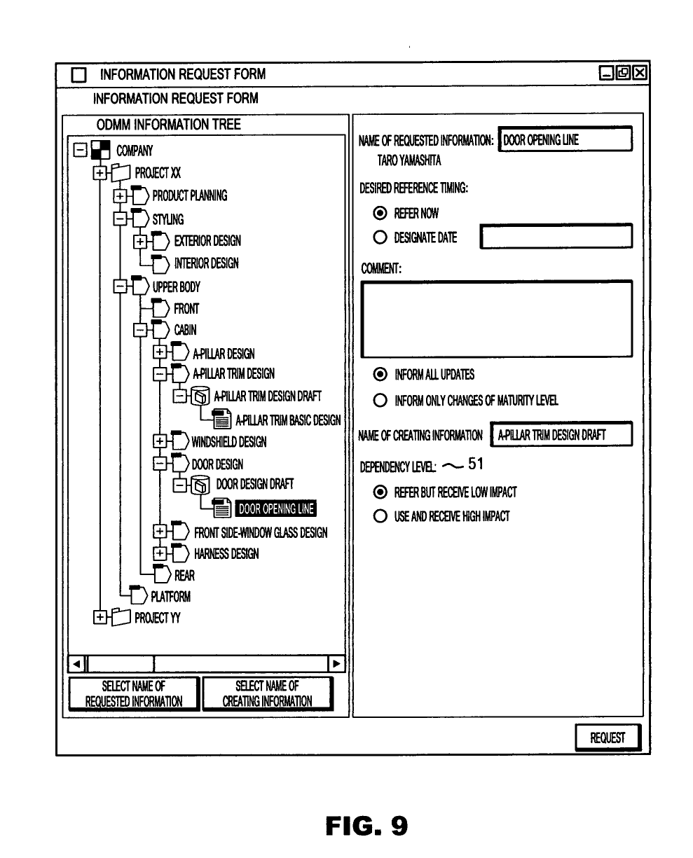

FIG. 9 shows an information request screen obtained by adding an extension to the information request screen shown in FIG. 8. The information request screen shown in FIG. 9 is provided with stepwise alternatives that indicate different dependency levels shown by reference numeral 51, and allows a user to make a choice of the alternatives. In FIG. 9, although there are only two levels of dependencies “refer but receive low impact” and “use and receive high impact,” more than two levels may be provided in other cases. Needless to say, the dependency level may otherwise be inputted directly as a numerical value.

In addition, a value of the dependency level may possibly be constrained in a case where various kinds of parameters in the present invention are specifically set. In a case where a certain piece of design information refers to a plurality of pieces of design information in the formulation example of the basic mode, it is necessary to set each value of the dependency level so that the sum of all the dependency levels, at which the certain piece refers respectively to the plurality of pieces of design information, is equal to or smaller than 1.

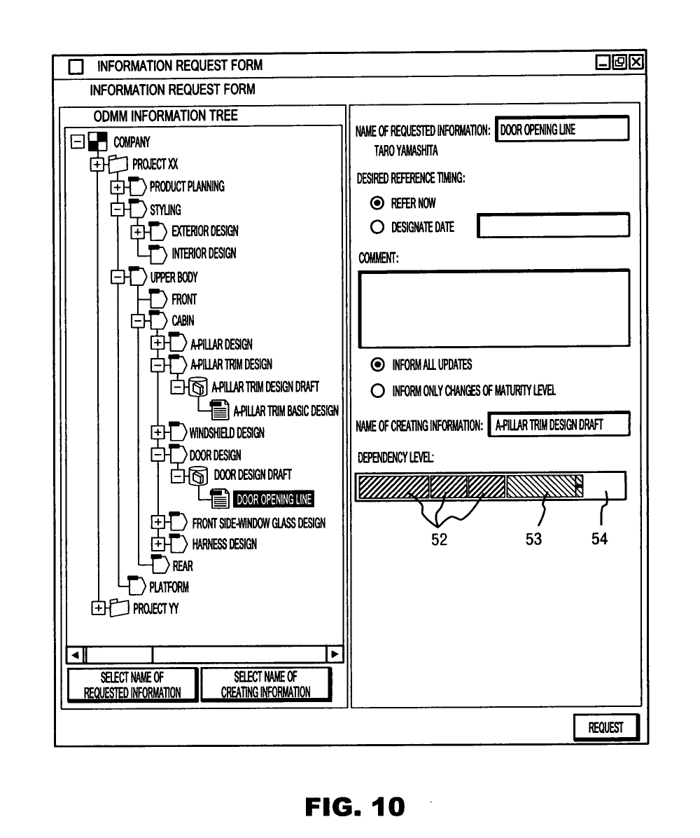

FIG. 10 is a diagram showing an example in which the information request screen is provided with an entry field to enforce the constraint on the dependency level. In FIG. 10, in an information request form, dependency levels (the length fixed) of already-existing pieces of information are displayed in a portion indicated by reference numeral 52, the dependency level (the length adjustable) of a newly set piece of information is displayed in a portion indicated by reference numeral 53, and an outer frame indicating the maximum value of the dependency level is displayed in a portion indicated by reference numeral 54. With this entry field, a user is allowed to input the dependency level.

Instead of the method of causing a user to make such an input, it is possible to employ the possible method in a case where an estimation can be made on the dependency level at which a certain kind of design information depends on another kind of design information, by using information accumulated in past times. In this case, the estimated dependency level can be provided as a default value, or the dependency level can be computed by using the estimated values without receiving an input by a user.

Alternatively, when a requested piece of design information is already registered in the system at the timing of requesting the piece of the design information, it is possible to see the maturity level of the requested piece of the design information. Here, for example, assume that, when the maturity level of the piece of design information to be referred to is low (that is, the piece of the design information is highly likely to be changed) a design process is not progressed in a way largely depending on the piece of the design information. On this assumption, the dependency level can be computed by using the size and maturity level of the design information to be referred to, and the computed dependency level may be provided as a default value. This can be achieved, for example, by using a method in which the dependency level is defined in advance so as to correspond to each of the stepwise maturity levels defined for each piece of the design information. Moreover, this technique can be utilized as an additional service incorporated into the system, in which an alert is issued when a piece of design information with a low maturity level is to be referred to at a high dependency level, for instance.

Obtaining an input as described above eliminates the necessity of many user inputs every time a change impact analysis is made, and allows costs needed for the analysis to be reduced.

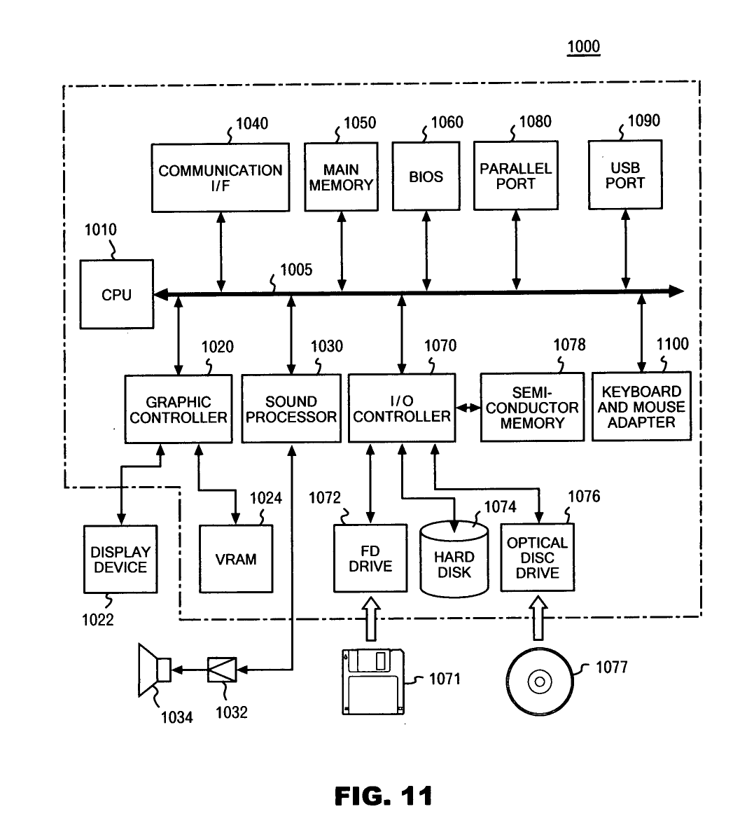

FIG. 11 shows an information processing apparatus 1000 as a typical hardware configuration example of the apparatus of the present invention. The following describes one example of the hardware configuration of this information processing apparatus 1000. The information processing apparatus 1000 includes a central processing unit (CPU) 1010, a bus line 1005, a communication I/F 1040, a main memory 1050, a basic input output system (BIOS) 1060, a parallel port 1080, a USB port 1090, a graphic controller 1020, a VRAM 1024, a sound processor 1030, an I/O controller 1070 and an input means such as a keyboard and a mouse adapter 1100. A storage medium such as a flexible disk (FD) drive 1072, a hard disk 1074, an optical disc drive 1076 or a semiconductor memory 1078 can be connected to the I/O controller 1070.

An amplifier circuit 1032 and a speaker 1034 are connected to the sound processor 1030. Moreover, a display device 1022 is connected to the graphic controller 1020.

The BIOS 1060 stores programs such as a boot program executed by the CPU 1010 at a startup time of the information processing apparatus 1000 and a program depending on hardware of the information processing apparatus 1000. The FD (flexible disk) drive 1072 reads a program or data from a flexible disk 1071, and provides the read-out program or data to the main memory 1050 or the hard disk 1074 via the I/O controller 1070.

A DVD-ROM drive, a CD-ROM drive, a DVD-RAM drive or a CD-RAM drive can be used as the optical disc drive 1076, for example. In this case, an optical disc 1077 compliant with each of the drives needs to be used. The optical disc drive 1076 can read a program or data from the optical disc 1077, and can also provide the read-out program or data to the main memory 1050 or the hard disk 1074 via the I/O controller 1070.

A computer program provided to the information processing apparatus 1000 is stored in a storage medium such as the flexible disk 1071, the optical disc 1077 or a memory card, and thus is provided by a user. This computer program is read from any of the storage media via the I/O controller 1070, or downloaded via the communication I/F 1040. Then, the computer program is installed on the information processing apparatus 1000, and then executed. An operation that the computer program causes the information processing apparatus 1000 to execute is the same as the operation in the foregoing apparatus, and the description thereof is omitted here.

The foregoing computer program may be stored in an external storage medium. In addition to the flexible disk 1071, the optical disc 1077 or the memory card, a magnet-optical storage medium such as an MD and a tape medium can be used as the storage medium. Alternatively, the computer program may be provided to the information processing apparatus 1000 via a communication line, by using, as a storage medium, a storage device such as a hard disk or an optical disc library provided in a server system connected to a private communication line or the Internet.

The foregoing example mainly explains of the information processing apparatus 1000. However, it is possible to achieve the same functions as those of the foregoing information processing apparatus 1000 by installing a program having the same functions on a computer, and then by causing the computer to operate as the information processing apparatus 1000. Accordingly, the information processing apparatus 1000 described as the embodiment can be achieved by using the foregoing method and a computer program of implementing the method.

The apparatus of the present invention can be achieved by employing hardware, software or a combination of hardware and software. In a case of implementation using a combination of hardware and software, a typical example is implementation of a computer system including a certain program. In this case, the certain program is loaded to the computer system and then executed, thereby the certain program causing the computer system to execute processing according to the present invention. This program is composed of a group of instructions each of which an arbitrary language, code or expression can express. In accordance with such a group of instructions, the system can directly execute specific functions, or can execute the specific functions after either/both (1) converting the language, code or expression into another one, or/and (2) copying the instructions into another medium. As a matter of course, the scope of the present invention includes not only such a program itself, but also a program product including a medium in which such a program is stored. A program for implementing the functions of the present invention can be stored in an arbitrary computer readable medium such as a flexible disk, an MO, a CD-ROM, a DVD, a hard disk device, a ROM, an MRAM and a RAM. In order to store the program in a computer readable medium, the program can be downloaded from another computer system connected to the system via a communication line, or can be copied from another medium. Moreover, the program can be compressed to be stored in a single storage medium, or be divided into more than one piece to be stored in more than one storage medium.

Heretofore, a change impact analysis has been achieved only by using a method requiring a large amount of time and cost, such as a method using an interview with a person in charge of each task. However, according to the present invention, it is possible to achieve a low-cost and semi-automatic change impact analysis in a general development project and a project, such as an automobile development project, heavily using parallel development. Moreover, application of the method of the present invention makes it possible to improve efficiency in change management that is indispensable to project management, and to achieve an analysis on risk associated with a state where a design is not fixed.

Finally, descriptions will be provided for a case where the foregoing method of the present invention is applied to an actual project management. Firstly, parameters needed for an analysis are extracted at a runtime of the project in a task management system as shown in FIG. 7. Here, it is possible to obtain the transitions of the dependency, the dependency level and the maturity level of each piece of design information in time series (at every timing of reference or the like). In a case where a certain piece of design information needs to be changed at a certain timing, the user needing to estimate the change impact can roughly estimate how much impact of the change is made on the total working period and costs of an entire project, by inputting the change level (change scale) to a program or the like employing the method of the present invention. Then, on the basis of the estimated result: a determination can be made as to whether or not to accept the change; if a plurality of alternatives exist for accomplishing the change, the alternative having the lowest impact can be adopted among others; or another similar determination or choice can be made.

In addition, in a case where a risk analysis of a project is desired to be made during a runtime of the project, application of the method of the present invention makes it possible to automatically obtain information such as one indicating which piece of design information would make a high impact if changed. For example, a change impact is estimated for every piece of design information by using a certain fixed change scale as an input. Thereby, it is possible to identify which piece of design information would make a high impact on the entire project if changed, and thereby to take various kinds of countermeasures based on the identified result.

Furthermore, in a case where a log of a past project as described above is available, use of the method of the present invention allows obtaining information indicating what kind of change in design information made a high impact on the entire project in the past. Such information can be used for a resource planning for a new similar project.

The proposed conventional techniques include: the method for estimating a change impact by using formats of artifacts; and the method for estimating the change impact on the basis of information on a similar process in the past, and of information on predefined dependency between processes. However, there has not been a method in which information and the like are obtained at a timing when a dependency actually occurs during a runtime of a process, and in which then a change impact is estimated in consideration of the work amount carried out after the occurrence of the dependency (that is, the work amount carried out on the basis of the referred information), as is the case with the method of the present invention.

Although the embodiments of the present invention have been described hereinabove, the present invention is not limited to the foregoing embodiments and the effects described in the embodiments are only examples and are not limited to those described in the embodiments or examples of the present invention.

1. An apparatus for analyzing a change impact that a change in one piece of design information makes on another piece of design information in a design and development process, comprising:
an input unit for receiving an input of a change target piece of design information and a change scale of the change target piece;
a change impact computing unit for computing a change impact on a creation process resulting from creating a piece of design information that refers to the change target piece of design information, on the basis of the change target piece of design information, the change scale, dependency between the pieces of design information, a dependency level, and a work amount after making a reference in the creation process; and
an output unit for outputting the change impact to an external unit.

2. The apparatus according to claim 1, wherein the change impact computing unit recursively computes the change impact on a piece of design information that indirectly refers to the change target piece of design information.

3. The apparatus according to claim 1, wherein the change scale is defined as a rework ratio that is a ratio of the work amount that becomes useless due to a rework to the work amount after making the reference.

4. The apparatus according to claim 1, wherein the dependency level is defined as a rate at which one piece of design information depends on another piece of design information.

5. The apparatus according to claim 3, wherein the change impact include variance of the change impact by using the probability density function thereof.

6. The apparatus according to claim 5, wherein, when a process completion time after the reference of a process of creating a piece of design information referring to the change target piece of design information is provided as a probability density function, the probability density function of the process completion time is updated by using the calculated distribution of change impact as the following equation:
$${g ( t )}^{′} = {\int }_{- ∞}^{∞} g ( t - {w}_{1} \cdot {r}_{01} ) \cdot {p}_{1} ( {r}_{01} ) d {r}_{01}$$
where t denote the process completion time, g(t) denotes the probability density function before update, w₁ denotes the work amount from a time of making a reference to the change target piece of design information to the present time, r₀₁ denotes a rework ratio, p₁ (r₀₁) denotes the probability density function of the rework ratio, and g(t)′ denotes the updated probability density function.

7. The apparatus according to claim 1, wherein the dependency level is obtained when the dependency between pieces of design information is acquired by using a GUI.

8. The apparatus according to claim 1, wherein, on the basis of design information accumulated in a past project information log, the dependency level is used as any one of a value directly inputted to the change impact computing unit, and a default value of a user input in the input unit.

9. The apparatus according to claim 1, wherein
the design and development process is a development process of designing a component of a motor vehicle, and
the design information is design information on the component.

10. A method for analyzing an impact which a change in one piece of design information makes on another piece of design information in a design and development process, comprising the steps of:
receiving an input of a change target piece of design information and a change scale of the change target piece;
computing a change impact on a creation process of creating a piece of design information referring to the change target piece of design information, on the basis of the change target piece of design information, the change scale, dependency between the pieces of design information, a dependency level, and a work amount after making a reference in the creation process; and
outputting the change impact to an external unit.

11. A computer program stored on a computer medium for analyzing an impact which a change in one piece of design information makes on another piece of design information in a design and development process, causing an information processing apparatus to execute the steps of:
receiving an input of a change target piece of design information and a change scale of the change target piece;
computing a change impact on a creation process of creating a piece of design information referring to the change target piece of design information, on the basis of the change target piece of design information, the change scale, a dependency between the pieces of design information, a dependency level, and a work amount after making a reference in the creation process; and
outputting the change impact to an external unit.
